(19) United States
(12) Patent Application Publication
(10) Pub. No.: US 2008/0059740 A1
(43) Pub. Date: Mar. 6, 2008

(54) Hardware for manually enabling and disabling read and write protection to parts of a storage disk or disks for users

(76) Inventors: George Madathilparambil George, Bangalore (IN); Nikhil George, Bangalore (IN)

Correspondence Address: GEORGE MADAT-H-ILPARAMBIL GEORGE, 307, VAYU, MY HOME NAVADWEEPA, MADHAPUR, HYDERABAD, 500081, omitted

(21) Appl. No.: 11/514,807

(22) Filed: Sep. 5, 2006

(51) Int. Cl. G06F 12/14

(52) U.S. Cl. 711/163

(57) ABSTRACT

Data protection is weak with the methods currently available and there are risks of corrupting important data, including system data accidentally by users or by malicious programs. We are proposing a method for improving access protection, more particularly, protection for data on mass memories by adding a hardware that will enable or disable read or write protection to portions of mass memories for each user. The hardware supports one or more users and two or more states for each supported user. The state of the hardware is manually controlled by the users. Depending on the configuration, each hardware state corresponding to a user corresponds to disabling or enabling read or write protection to some portions of a mass memory or mass memories for that user.

### BACKGROUND OF THE INVENTION

The present invention relates to controlling access for users to portions of mass memories such as hard disks, storage arrays, JBODs (Just a Bunch of Disks), RAID storage or future technologies for mass memories. We also use the word storage to refer to mass memories in this invention.

Current technologies provide protection at the file system level and a malicious program or user can get access as a privileged user and read confidential user data or corrupt user data. It requires hardware support to gain complete protection from malicious programs. Prior art technologies allow either full access or one level of hardware controlled restricted access. This level of hardware support is not sufficient to protect all users. It is possible for privileged users to corrupt data unintentionally by installing a malicious program or by manual error during full access.

We refer to the software, firmware and hardware components that control access to mass memories as storage components. The storage components are file systems, volume managers, storage stack, interface drivers, Host Bus Adapters, disk controllers, etc. File systems create a logical view of data in the form of files and directories. Some systems contain volume managers which present logical disks to its users such as file systems. The storage stack provides access to physical disks for file systems, volume managers and users who do read or write directly to disks (raw access). Interface drivers control Host Bus Adapters (HBAs) and provide an interface for the storage stack to issue storage commands and transfer data from and to the storage. On systems that do not have a storage stack, file systems interact directly with interface drivers. The Host Bus Adapters are connected to storage array controllers or disk controllers through an interconnect mechanism such as SCSI, SAS, SATA, FC, IDE, etc. A firmware on a disk controller or the disk controller hardware controls operations on the disk in response to commands received from Host Bus Adapters. A firmware on the storage array controller or the storage array controller hardware controls operations on the array in response to commands received from Host Bus Adapters.

There are different methods for access control such as non-privileged users in UNIX or Windows operating systems who cannot access all parts of mass memories (storage). But a malicious program or user can sometimes exploit security weaknesses in an operating system, to get access as a privileged user. This will allow malicious users to gain access to critical data belonging to other users or corrupt users' data.

There is serious risk to users' data when their laptops are stolen or when someone gains access to a user's computer in the user's absence.

There is serious risk to users' data when a privileged user is malicious.

There are many methods for protecting user memories which do not require manual action for enabling and disabling protection; Such protections can be compromised by malicious programs by emulating the required software behavior.

U.S. Pat. No. 6,330,648 illustrates a method of adding protection against malicious programs using a manually controlled hardware with two states. By default the protection is enabled and has a mechanism to manually switch off the protection. This invention will not be able to provide protection for portions of storage belonging to each user, as is possible using our invention. Another drawback of the invention is that the solution cannot be used with mass memories which are already manufactured.

US Patent application 20060117156 illustrates a method of adding protection for non-volatile memories against malicious programs using a manually controlled hardware with two or more states, but only two states used for protection. One state has protection enabled and other state has protection disabled. This invention will not be able to provide protection for portions of storage belonging to each user, as is possible using our invention.

FIG. 1 shows an example of storage components that allow a process in a computer to connect to mass memories such as hard disks, storage arrays, etc. The computer 101 has an internal disk 102. The computer 101 is connected to an external disk 103, a storage array 104 and a JBOD (Just a Bunch Of Disks) 105. The user processes running on the computer interact with File System 106, Volume Manager 107, or the storage stack 108. File systems 106 interact with Volume Managers 107 and Storage Stack 108. The Volume Manager 107 interacts with Storage Stack 108. The storage stack sends disk read or disk write requests to Host Bus Adapter (HBA) through Interface Drivers 109, 110. The Interface Drivers control Host Bus Adapters (HBAs) 111, 112, 113, 114. The HBAs are connected to disk or array controllers through storage interconnects such as SCSI bus, SAS, SATA or FibreChannel network. In this example, HBA#1 111 is connected to Disk Controller 115, HBA#2 112 is connected to Disk Controller 116, HBA#3 113 is connected to Array Controller 117 and HBA#4 114 is connected to Disk Controller 118 in the JBOD 105.

Disk controllers control operations of the disk or disks connected to them. Disk firmware controls operations of disk controllers. Array controllers controls operations of disk controllers in arrays. Array controller firmware control operations of array controllers.

A computer may have one or more file systems. Some computers do not contain volume managers. Some computers may contain one or more volume managers. Some computers do not contain a storage stack.

### BRIEF SUMMARY OF THE INVENTION

Mass memories include hard disk drives, storage arrays, JBODs, RAID storage, etc. It is the object of the present invention to use a hardware which support one or more users and supports two or more states for each user to control access to portions of mass memories to which a user has access. We refer to this hardware as Disk User Protection Hardware or DUPHardware. It requires a manual action on the DUPHardware to change the state of the DUPHardware corresponding to each user. We refer to the manual action to change state corresponding to a user on DUPHardware as DUPManualAction.

According to the invention, the software, firmware and hardware that implement access restrictions, check the current state of the DUPHardware and fail each read or write operation which do not meet access restrictions permitted by the current state of the DUPHardware corresponding to the user on whose behalf the read or write operation is initiated.

Privileged users provide users access to portions of mass memories. The configuration containing access restrictions for each user is written to an area of a mass memory to which only the privileged users has access. This area of the mass memory is protected by the DUPHardware.

According to the invention, a configuration software allows a user or privileged users to further divide the portions of mass memory or memories to which the user has access and associate each state of the DUPHardware corresponding to a user with disabling or enabling write or read access to portions of mass memory or memories. Preferably, only a user is allowed to configure access restrictions to portions of mass memory or memories to which the user has been given access by a privileged user.

The configuration software configures one or more storage components and/or new modules to disable or enable read or write access for a user to portions of a mass memory or memories depending on the state of the DUPHardware corresponding to a user.

If storage components other than the file systems implement access restrictions, the file systems need to tag a read or write operation with the identifier of the current user of a buffer in the file system buffer cache. Other storage components may not be able identify the user on whose behalf a read or write request is initiated, without this tag. If more than one user is using a buffer in buffer cache in a file system, the accesses by different users need to be serialized so that there is only one user for a buffer at any point of time. Since only one user is associated with a buffer at any time, read or write requests can be tagged with the identifier of that user. The buffer in the buffer cache is written (flushed) to the mass memory (non-volatile storage) if it is dirty (a buffer becomes dirty when a user writes to the buffer), before the buffer is assigned to another user.

If storage components other than the file systems implement access restrictions, the DUPHardware is not allowed to change the state corresponding to a user until all dirty buffers corresponding to the user are written to mass memory or memories.

The DUPManualAction on a DUPHardware may be pressing one or more buttons and/or toggling one more switches and/or changing jumper positions etc., on the DUPHardware.

Preferably, the DUPManualAction causes the DUPHardware or a computer to prompt the user who initiated the DUPManualAction for a password.

### BRIEF DESCRIPTION OF THE SEVERAL VIEWS OF THE DRAWINGS

FIG. 1 illustrates different components of the storage system on a computer.

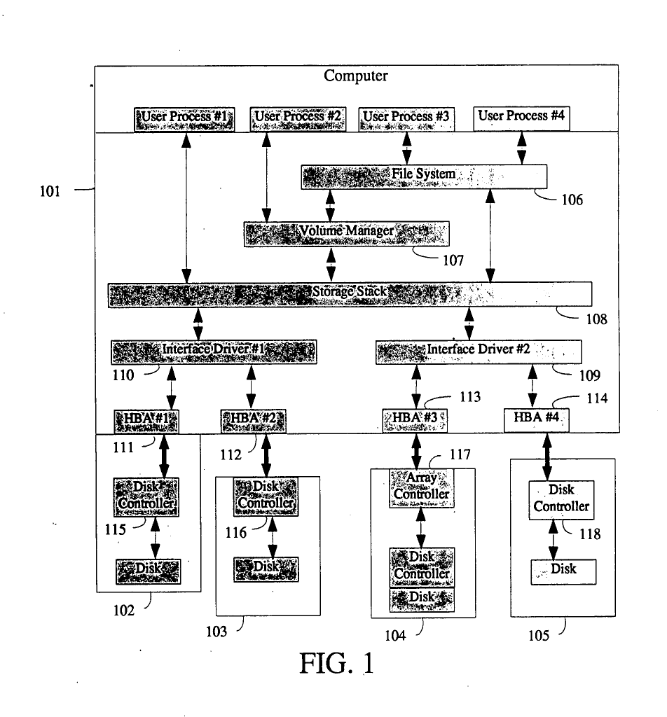

FIG. 2 illustrates an example for states of a DUPHardware that accepts DUPManualActions.

FIG. 3A illustrates an example for states of a device driver that control the DUPHardware and a software module that prompts users for password.

FIG. 3B illustrates a file system module which flushes dirty buffers of a user in the file system buffer cache to mass memory and removes association between the user and the buffers in the buffer cache, before sending message containing identifier of the user to the DUPHardware device driver.

FIG. 4 illustrates an example for states of a module in the storage component that implement access restrictions for each user.

FIG. 5 illustrates an example of how different components interact when used with a DUPHardware that accepts DUPManualActions.

### DETAILED DESCRIPTION OF THE INVENTION

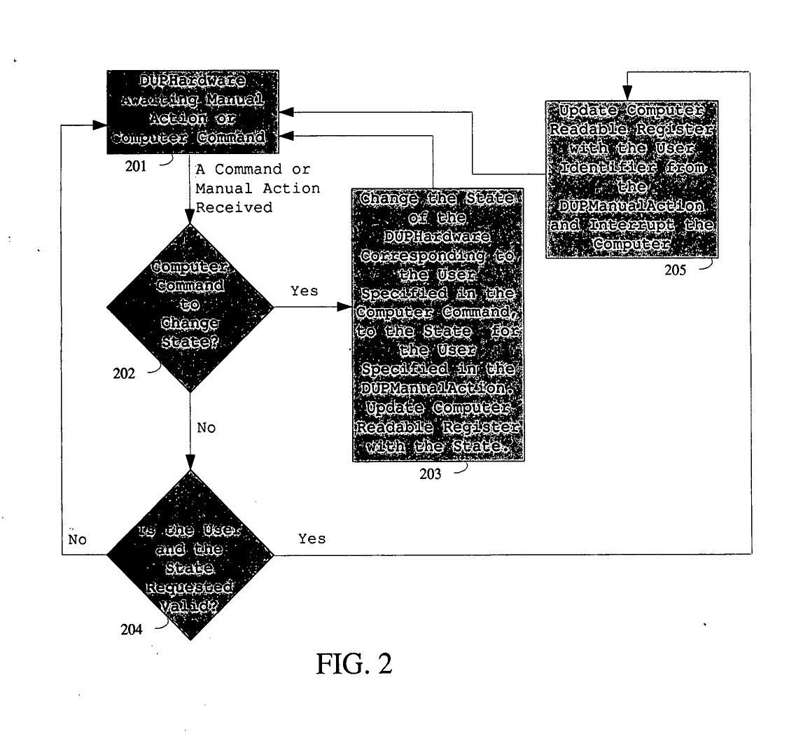

FIG. 2 illustrates an example for different states of a DUPHardware that is attached to a computer and accepts DUPManualActions. The DUPHardware awaits 201 either a DUPManualAction from a user or a computer command. The DUPHardware checks 202 the type of input, DUPManualAction vs a command from computer. When a DUPManualAction is received, the DUPHardware checks 204 whether the user and the state requested by the DUPManualAction are valid. If the user or state is invalid, the DUPManualAction is ignored (discarded). If the user and state are valid, the DUPHardware updates 205 a register readable by the computer, with the identifier of the user and interrupts 205 the computer using a hardware interrupt, such as PCI interrupt. The computer cannot write into the DUPHardware register containing identifier of the user. The DUPHardware then returns to the state where it waits for a DUPManualAction or a computer command. When DUPHardware receives a computer command 203 to change the state of the DUPHardware corresponding to a user, the DUPHardware changes the state of the user to the state selected through DUPManualAction by the user. Since the state requested by the user is not communicated to the computer, no malicious software can control the state of the DUPHardware corresponding to a user. The DUPHardware updates a register readable by the computer 203, with the state corresponding to the user. The computer cannot write into the register containing the state corresponding to a user.

Preferably, if more than one DUPManualAction is received for the same user before the state corresponding to the user is changed, the DUPHardware will change state corresponding to the user to the state corresponding to the last DUPManualAction made by the user. Optionally, if more than one DUPManualAction is received for the same user before the state corresponding to the user is changed, the DUPHardware will change state corresponding to the user to the state corresponding to first DUPManualAction made by the user after the last state change. Some implementations may even change the state to one of the states corresponding to a DUPManualAction between the first manual action after the last state change and the last manual action depending on some other criteria.

The DUPManualAction on a DUPHardware may be pressing one or more buttons and/or toggling the position of one or more switches and/or turning a wheel and/or changing one or more jumper positions and/or any other DUPManualAction supported by the DUPHardware.

The DUPHardware may use registers or memory locations readable by the computer to communicate the identifier of the user who initiated DUPManualAction and the current state of DUPHardware corresponding to a user. A computer should not be allowed to write into these registers or memory locations. This improves security as a malicious software will not be able to manipulate the state of the hardware corresponding to each user.

A DUPHardware may control one or more mass memories. There could be one or more DUPHardwares on a computer, each controlling states corresponding to a mutually exclusive set of users. Some implementations may use more than one DUPHardware on the same computer, each controlling states corresponding to sets of users which are not mutually exclusive, but we do not recommend such implementations.

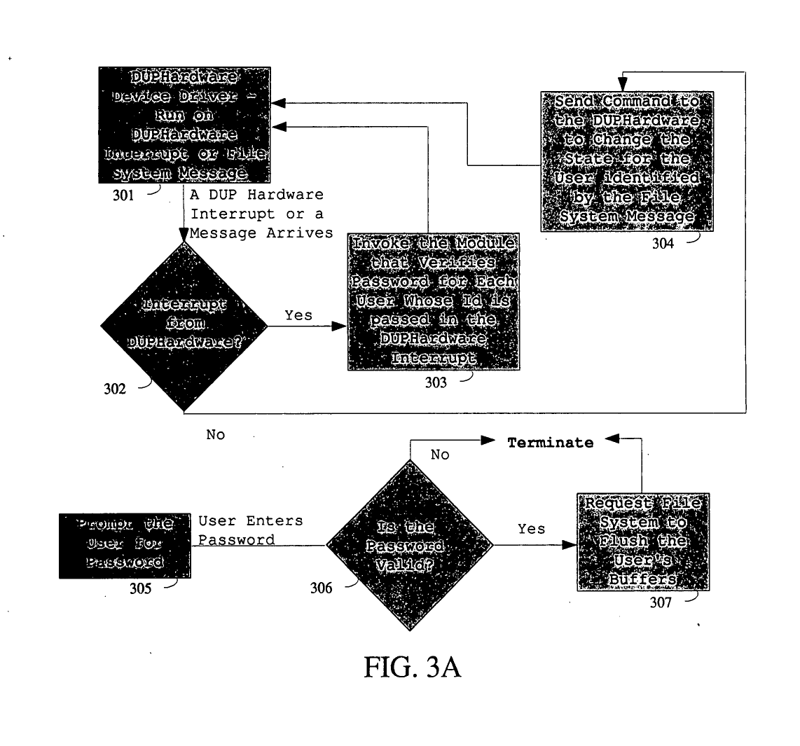

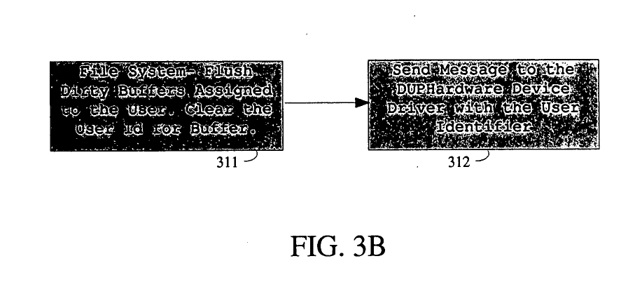

FIG. 3 illustrates an example for states of a device driver which runs on a computer and controls the DUPHardware which accepts DUPManualActions. The DUPHardware device driver runs 301 either when an interrupt from the DUPHardware or a message from the file system arrives. The DUPHardware device driver checks 302 the type of input, interrupt vs. file system message. When an interrupt is received 303, the driver invokes a software module that prompts 305 user whose identifier is present in the DUPHardware register (or memory), for a password. If the password is invalid 306, the software module terminates. If the password is valid 307, the software module sends a request to the file system to flush dirty buffers belonging to the user and terminates. A buffer in the file system buffer cache is considered dirty if the user has written into the buffer. The file system flushes (writes to mass memories) 311 the dirty buffers in the file system buffer cache belonging to the user, resets the user identifier in all buffers that were assigned to the user and then, sends a message 312 containing the user identifier, to the DUPHardware device driver. The DUPHardware device driver sends 304 a command to the DUPHardware to change the state corresponding to the user.

There could be different behaviors for the software that accepts passwords. If the password entered by a user is invalid, the software could prompt the user for password and accept a new password from the user until a valid password is received or until the maximum number of retries is reached or user cancels the password entry. The software that supports password retries, will terminate only if a valid password is not received even after maximum number of retries or if the user cancels the request to reenter the password. There are different ways the software that accepts password could be implemented, such as a daemon, a process etc. The software may also prompt for a user name in addition to the password. The way the password processing software behaves and how it is invoked are implementation specific.

If there are more than one file system on a computer, the password validating software that received a valid password must send messages containing the identifier of the user to all the file systems on the computer. The DUPHardware device driver will command DUPHardware to change the state corresponding to a user only after all the file systems flush dirty buffers assigned to the user and resets the user identifier in all the buffers that were assigned to the user.

A DUPHardware device driver may control one or more DUPHardware. There could be one or more DUPHardware device drivers running on a computer each controlling a mutually exclusive set of DUPHardware.

There could be one or more storage components or new modules that implement access control according to the invention on a computer. We refer to the modules that implement access control as DUPImplementers. When an upper layer module of the DUPImplementer sends a new read or write request to the a DUPImplementer, the DUPImplementer will get the current DUPHardware state corresponding to the user on whose behalf the read or write request was created. The DUPImplementer is configured with information on portions of mass memories and type of access (read or write) allowed or denied for each portion of mass memory, for each combination of user and state. The software component checks the portions of mass memory or mass memories accessed by the read or write request against the configuration. If a read or write requests violates the access restrictions, the read or write request is not allowed to proceed and is returned with error. If no configuration is present for a portion of mass memory, DUPImplementers are configured either to allow or block the read or write request that access such a portion.

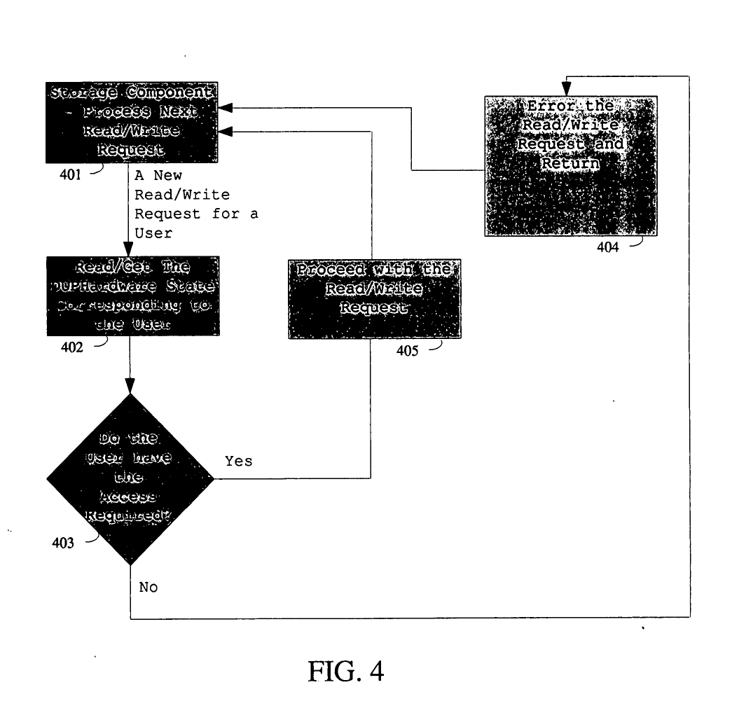

FIG. 4 illustrates an example for a storage component that is a DUPImplementer. The storage component processes read or write requests 401. When a new read or write request arrives, the storage component will read or get the DUPHardware state 402 corresponding to the user on whose behalf the read or write request was created. The storage component checks 403 whether the read or write request violates access restrictions configured corresponding to the current state of the user. If access is not allowed 404, the read or write request is returned to the upper layer with error. If the access is allowed 405 the read or write request is allowed to proceed.

A user is allowed access to portions of a mass memory or memories by privileged users. The portions of mass memories to which each user has access is not mutually exclusive. The portions of mass memories to which a user has access and the type of access is written to a portion of the mass memory to which only privileged users has access. The area of the mass memory where this configuration is stored is protected by the DUPHardware.

A configuration software allows each user to further divide these portions of mass memory or mass memories to which the user has access. The configuration software further allows a user to enable or disable read or write access to each of these divided portions and associate the access restrictions to a state of the DUPHardware corresponding to the user. Preferably, the access restrictions associated with each state is independent of access restrictions associated with other states of the DUPHardware corresponding to the same user. Optionally, access restrictions are such that there are dependencies between access restrictions corresponding to some or all of the states corresponding to a user.

Preferably, the configuration corresponding to a user is written to a predefined area of the mass memory or mass memories, selected on the basis of the user identifier and write to this area is enabled for the user only on one or more states of DUPHardware corresponding to the user. Preferably, no other user, including privileged users has write or read access to this area of the mass memory or mass memories.

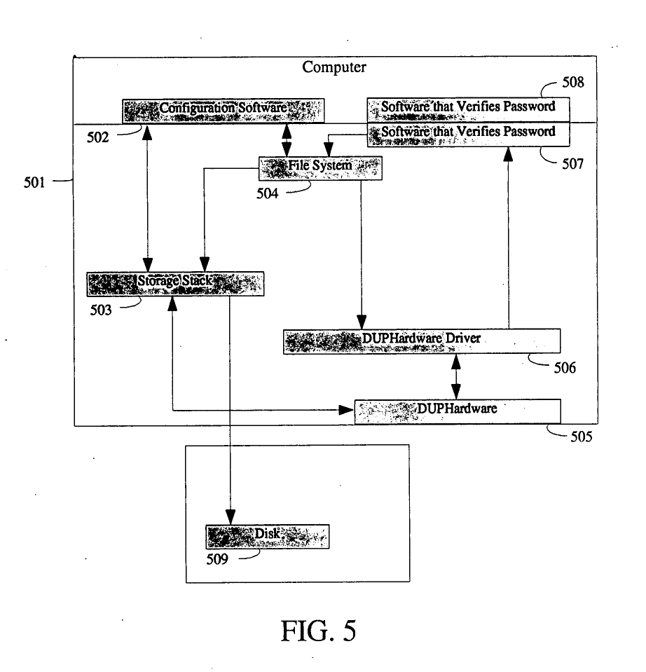

FIG. 5 illustrates an example of interaction between different components in a computer 501 that implement the read and write protection for each user to parts of a mass memory, when used with a DUPHardware 505 that accepts DUPManualActions. Only components that are changed or affected by the invention are shown. The DUPHardware 505 writes the identifier or the user in a register readable by the computer and interrupts the computer when a user performs DUPManualAction to change the state corresponding to the user. The DUPHardware device driver 506 processes the interrupt and reads the identifier of the user from the DUPHardware. The DUPHardware device driver invokes a software 507 that prompts the user for password, accepts the password entered by the user and verifies it. In this example, part of this software 507 is part of the operating system and part of the software 508 runs as a user process. If the password entered by the user is invalid even after maximum number of retries or if the user cancels password entry, the software process 508 will terminate. If the password entered by the user is valid, the software will send a request to the file system 504 to flush dirty buffers assigned to the user. The file system 504 goes through the list of buffers assigned to the user, writes (flushes) the buffer to the mass memory if the user had written into it (dirty) and removes the association between the user and the buffer. After removing association between the user and all the buffers that were assigned to the user, the file system 504 sends a message to the DUPHardware device driver 506. The DUPHardware device driver sends a command to the DUPHardware to change its state corresponding to the user. In this example, the configuration software 502 configures the file system 504 and the storage stack 503 to implement access restrictions for users. The storage stack gets the state of DUPHardware corresponding to a user by reading the computer readable memory in the DUPHardware containing states. The file system gets the state of DUPHardware corresponding to a user through DUPHardware device driver, which reads the computer readable memory in DUPHardware containing states. The state of the DUPHardware corresponding to a user is used by both the storage stack and the file system to implement access restrictions for the user configured by the configuration software. The configuration software interacts with the storage stack to write the configuration to the disk 509. The configuration is read by the storage stack, the file system and the configuration software. The file system and the configuration software interact with the storage stack to read the configuration from the disk 509. The components which are not affected by the invention such as Interface Driver, HBA, Disk Controller, Disk Controller firmware etc., are not shown.

The protection provided by DUPHardware need not be limited to mass memories alone. Other modules that implement access protections could check the current state of the hardware corresponding to a user and implement access restrictions based on the current state and configuration associated with the state for the module implementing access restrictions.

Since DUPHardware or part of DUPHardware can be enclosed in the same mass memory that is being protected, there is less risk to data even if the laptop of a user is stolen.

What is claimed is:

1. A method for implementing access protection, more particularly protecting user data on a mass memory or mass memories by
i) Using a hardware supporting one or more users and two or more states for each supported user; This hardware is referred to as Disk User Protection Hardware or DUPHardware.
ii) The state of the DUPHardware corresponding to a user being controlled by manual action by that user on the DUPHardware; The manual action to change the state corresponding to a user is referred to as DUPManualAction.
iii) Preferably, the DUPManualAction causes a computer to prompt the user who initiated the DUPManualAction or a privileged user for a password. The computer rejecting the DUPManualAction if password verification fails.
iv) Preferably, the DUPHardware interrupting the host computer when a user attempts to change the state of the DUPHardware by performing DUPManualAction;
v) Preferably, after file systems writing dirty buffers assigned to the user to the storage and removing association between the user and buffers that were assigned to the user, the DUPHardware device driver allowing the DUPHardware to change the state for the user to the state requested by the user through the DUPManualAction; Where DUPHardware device driver is the software component that control the DUPHardware; Where a buffer becoming dirty when a user writes to the buffer.
vi) A user having access to one or more portions of a mass memory or mass memories;
vii) The portions of a mass memory to which a user has access, being further divided and access to these divided portions for the user being enabled only if the state of the DUPHardware corresponding to the user allow such access;
viii) A configuration software allowing a user or privileged users to associate one or more states of the DUPHardware corresponding to a user with disabling or enabling write or read access to portions of one or more mass memories;
ix) The configuration software configuring one or more of storage components and/or new modules to disable or enable read or write access for a user to portions of mass memory or mass memories depending on the state of the DUPHardware corresponding to a user; The storage components being file systems, storage array controller firmware or hardware, disk controller firmware and hardware, storage stack, volume managers, Host Bus Adapter Interface drivers, Host Bus Adapter; A module that implements access protection based on the state of DUPHardware being referred to as DUPImplementer.
x) Preferably, file systems tagging read or write requests to mass memories with the identifier of the current user of the buffer being written or read; Preferably, the access to each buffer in a file system buffer cache by different users are serialized and a dirty buffer is written to the storage before access is given to another user;
xi) Preferably, the operating system tagging each raw disk read or write request with the user identifier of the user issuing the raw disk read or write;
xii) Optionally, read or write commands from the computer to a mass memory or mass memories being tagged with identifier of the user on whose behalf the read or write is initiated;
xiii) A DUPImplementer using the identifier of the user in the read or write request and current state of the DUPHardware corresponding to the user to identify the parts of mass memory or mass memories to which access is restricted; The DUPImplementer comparing the part of mass memory or mass memories being accessed by read or write request and type of access, to the configured access restrictions. The storage components failing read or write requests which violate access restrictions.
xiv) Preferably, there exists a DUPHardware device driver that runs on the computer to which a DUPHardware is connected and the DUPHardware device driver controls the DUPHardware.

2. A method as claimed in (1), where the DUPManualAction on a DUPHardware may be pressing one or more buttons and/or toggling the position of one or more switches and/or turning a wheel and/or changing one or more jumper positions and/or any other manual action accepted by the DUPHardware.

3. Preferably, DUPHardware of claim (1) or part of it is enclosed in the same enclosure as the mass memory or mass memories which is being write protected by the DUPHardware.

4. A DUPHardware of claim (1), could be used to control the state of one or more mass memories.

5. Optionally, a computer using more than one DUPHardwares of claim (1) to control access to portions of the mass memory or mass memories for the users of the computer. Preferably, each DUPHardware on a computer manages a mutually exclusive set of users of the computer.

6. Optionally, DUPHardware device driver of claim (1) polling DUPHardware registers to check whether a user performed DUPManualAction.

7. Preferably, a user configuring a password on the computer on which the DUPHardware device driver controlling the DUPHardware of claim (1), is running; The DUPManualAction on the DUPHardware causing an interrupt to the computer after updating a computer readable register or memory location with the identifier of the user who requested the DUPManualAction; The DUPHardware device driver reading the user identifier and invoking directly or indirectly an application or module that prompts the user for a password; On successful verification of the password by a software/module, the software module sending a message to the file systems; The file systems writing dirty buffers in the buffer cache which were assigned to the user, to the mass memory or mass memories and removing association between the user and all buffers in the buffer cache that were assigned to the user and then sending a message to the DUPHardware device driver. The DUPHardware device driver sending a command to the DUPHardware to change the state for the user.

8. Optionally, the password verification of claim (6) is done by DUPHardware device driver and/or the DUPHardware by software/module of claim (6) sending a message to DUPHardware device driver.

9. Optionally, there are no passwords configured on the computer to validate the users who initiate DUPManualActions of claim (1); The DUPManualAction on the DUPHardware causing an interrupt to the computer after updating a computer readable register or memory location with identifier of the user who requested DUPManualAction;
The DUPHardware device driver reading the user identifier and sending a message to the file systems containing the user identifier. The file systems writing dirty buffers in the buffer cache which were assigned to the user to the mass memory or mass memories and removing association between the user and all buffers in the buffer cache that were assigned to the user and then sending a message to DUPHardware device driver. The DUPHardware device driver sending a command to the DUPHardware to change the state for the user.

10. Where only file systems implement access protection, writing of dirty buffers of claim (7) or claim (9) not being required;

11. Preferably, the user being prompted for password is same as the user who initiated the DUPManualAction of claim (1). Optionally, the user or users being prompted for password is not same as the user who initiated the DUPManualAction.

12. Preferably, the DUPHardware device driver of claim (1) or disk/array controller firmware of claim (1) or both being able to detect the state of the DUPHardware corresponding a user.

13. The DUPHardware device driver of claim (1) detecting the state of the DUPHardware of claim (1) corresponding to a user by polling the DUPHardware or when the DUPHardware interrupts the computer on which the DUPHardware device driver is executing; The interrupt may be a PCI interrupt.

14. The firmware of claim (12) detecting the state of the DUPHardware of claim (1) corresponding to a user by polling DUPHardware state or when the DUPHardware of claim (1) creates an interrupt detectable by the firmware.

15. The storage “software” components of claim (1) which are configured by configuration software of claim (1), identifying the state of the DUPHardware of claim (1) corresponding to a user either by polling the DUPHardware or by getting the state from the DUPHardware device driver of claim (1) or by getting the state from another module; The storage “software” components being all storage components of claim (1) which run on the host issuing a read or write request to mass memories.

16. A method as claimed in (1), a user having access to portions of a mass memory or memories. The portions of mass memories to which each user has access is not mutually exclusive. The portions of mass memories to which a user has access and the type of access is written to a portion of the mass memory to which only privileged users have access. The area of the mass memory where this configuration is stored is protected by the DUPHardware.

17. The configuration software of claim (1) allowing a user or a privileged user to configure portions or areas of a mass memory or mass memories to which the user has access, to enable or disable read or write access for each configured portion for the user and to associate the access restrictions to the portions of a mass memory or mass memories to a state of the DUPHardware of claim (1) corresponding to the user; Preferably, only a user is allowed to configure access restrictions for himself or herself within the portion of mass memory or mass memories allocated to the user.

18. Optionally, the configuration of claim (17) is such that by default all access is disabled for the user to portions of mass memory to which a user has access and when a portion of mass memory is configured for read and/or write access and the access is associated to a DUPHardware state corresponding to a user, the access to the portion of mass memory gets enabled for the user while the DUPHardware is in that state; or the configuration is such that by default all access is enabled for the user to portions of mass memory to which a user has access and when a portion of mass memory is configured to disable read and/or write access and the disabled access is associated to a DUPHardware state corresponding to a user, the access to the portion of mass memory gets disabled for the user while the DUPHardware is in that state.

19. Preferably, the configuration of claim (17) corresponding to a user, is written to a predefined area of the mass memory or mass memories selected on the basis of the user identifier and write to this area is enabled for the user only on one or more states of DUPHardware corresponding to the user. Preferably, no other user, including privileged users have write or read access to this area of the mass memory.

20. Preferably, the configuration software of claim (17) allowing users to see which portions of a mass memory or mass memories to which each file or directory is mapped to; Preferably, the portions or areas shown by the configuration software for a directory include portions of mass memory or mass memories used by subdirectories and all files in the directory and subdirectories.

21. The portions of mass memory or memories of claim (1) on which access restrictions are configured corresponding to a state of the DUPHardware corresponding to a user, need not be mutually exclusive to portions of mass memory or memories on which access restrictions are configured corresponding to another state of the DUPHardware corresponding to the same user.

22. The portions of mass memory or memories of claim (1) on which access restrictions are configured corresponding to a state of the DUPHardware corresponding to a user need not be mutually exclusive to portions of mass memory or memories on which access restrictions are configured corresponding to a state of the DUPHardware for a different user.

23. Where a DUPImplementer of claim (1) checking a read/write request from a user against the access restrictions corresponding to the current state of the DUPHardware for the user and failing read/write requests if it violates the access restrictions.

24. If there is no entry in the configuration corresponding to a portion of mass memory or mass memories corresponding to a state of a user, all DUPImplementers of claim (1) on a computer being configured to either block or to allow read/write requests to such portions of mass memory or mass memories while the DUPHardware is in that state.

25. Preferably, a method as claimed in (1), the file system tagging read or write requests to mass memories with the identifier of the current user of a buffer in the file system buffer cache; If more than one user is using a buffer in the file system buffer cache, the accesses are serialized; A dirty buffer in the buffer cache is written to the mass memory before the buffer is assigned to another user; Where a dirty buffer is a buffer into which the user has written.

26. Preferably, when the state change of the DUPHardware of claim (1) is initiated by a user through a DUPManualAction, all dirty buffers of claim (7) or claim (9), assigned to the user are written to the mass memory or mass memories before the DUPHardware is allowed to change the state corresponding to the user.

27. The portions or areas of claim (1) of a mass memory may be identified using parameters like directories and files, or physical blocks or disk sectors or logical blocks or a combination of head, cylinder and sector. The configuration software configuring a given parameter (such as logical block number) only on those storage software components that recognizes the parameter.

28. The DUPImplementer of claim (1) which is configured to check access permissions, checking whether a read or a write operation requested in each read or write request to a mass memory, is permitted as per access restrictions corresponding to the current state of the DUPHardware corresponding to the current user; The storage component failing the read or write operations which violates the access restrictions. More particularly, the DUPImplementer of claim (1) verifying the portions of mass memory or mass memories configured for restricting access and type of access restriction in the current state of the DUPHardware of claim (1) for the corresponding user, against portions of mass memory or mass memories to be written or read as per each read or write request and failing read or write requests which are not permitted.

29. Preferably, the access restrictions of claim (1) associated with each state corresponding to a user being independent of access restrictions associated with other states of the DUPHardware corresponding to the same user.

30. Optionally, access restrictions of claim (1) associated with each DUPHardware state corresponding to a user having dependency on access restrictions associated with one or more states of the DUPHardware corresponding to the same user.

31. Preferably, read or write commands to mass memories being tagged with the tag of claim (25) or a value derived from it;

32. Optionally, the tag of claim (25) or a value derived from it being passed to a fibrechannel mass memory using OX_ID field in a Fibre Channel read or write command.

33. Where array or disk controller firmware or hardware of claim (1) is not able to identify the user who initiated a read or write request, the array or disk controller firmware or hardware allowing a read or write request if it is permitted for any of the currently active users.

34. Optionally, one or more steps of claim (7) or claim (9) could be avoided for a DUPHardware to change state corresponding to a user after a DUPManualAction.

35. A method as in claim (34) where DUPHardware changes state as soon as a user enters a valid DUPManualAction.

36. Preferably, the registers or the memory locations of claim (7) or claim (9) containing states of a DUPHardware is not writable by the computer.

37. A method as claimed in (1), DUPHardware could be used by any module that implements access restriction on a computer.

38. Preferably, a DUPHardware of claim (1) presents itself as an input/output device to a computer; More particularly, a DUPHardware is preferably a PCI card; Optionally a DUPHardware is an input/output device attached directly or indirectly to the motherboard of a computer;

39. Optionally, a DUPHardware of claim (1) presents itself as a memory to a computer;

40. The configure software of claim (1) consists of one or more processes or modules.

41. The method claimed in (1) being applicable to all types of mass memories such as storage arrays, JBODs, RAID storage, independent disks and internal disks of computers.

42. The method claimed in (1) being used with future technologies for mass memories.
